(19) United States
(12) Patent Application Publication
(10) Pub. No.: US 2026/0243710 A1
(43) Pub. Date: Aug. 20, 2026

(54) ARTICLE INSPECTION APPARATUS AND PERFORMANCE CONFIRMATION METHOD THEREOF

(71) Applicant: ANRITSU CORPORATION, Kanagawa (JP)

(72) Inventors: Takashi KANAI, Kanagawa (JP); Tatsuki KOMATSUBARA, Kanagawa (JP)

(21) Appl. No.: 19/533,421

(22) Filed: Feb. 9, 2026

(30) Foreign Application Priority Data
Feb. 20, 2025 (JP) 2025-025626

(51) Int. Cl. G01N 23/083; G01N 23/04; G01N 23/18

(52) U.S. Cl. CPC G01N 23/083; G01N 23/04; G01N 23/18; G01N 2223/3307

(57) ABSTRACT

An article inspection apparatus includes: a sensitivity correction unit configured to execute light reception sensitivity correction of an X-ray detector and output an X-ray inspection image after the sensitivity correction; an image quality change detection unit configured to detect an occurrence of a change or a change factor of image quality in the X-ray inspection image; a reference image storage unit configured to store a reference image of a non-defective product; an evaluation image generation unit configured to generate an evaluation image obtained by synthesizing the reference image with the X-ray inspection image after the sensitivity correction at a time of image quality change factor detection; and an inspection performance evaluation unit configured to determine propriety of a determination result of a determination unit after causing an image processing unit to perform image processing on the evaluation image.

### TECHNICAL FIELD

The present invention relates to an article inspection apparatus and a performance confirmation method thereof, and particularly, to an article inspection apparatus that determines a quality state of an article by performing predetermined image processing on an X-ray inspection image of the article, and a performance confirmation method for confirming whether or not there is performance degradation accompanied by degradation of image quality of the X-ray inspection image.

### BACKGROUND ART

In an article inspection apparatus using X-rays (electromagnetic waves transmitted through an article), generally, an inspection object is irradiated with X-rays within an inspection region in an article transport section, the X-rays transmitted through the inspection object are incident on an X-ray detector and are detected, whereby a detection signal that enables image formation is output from the X-ray detector, and image data of an X-ray inspection image of the inspection object is generated based on the output signal.

In such an article inspection apparatus, generally, an X-ray detector including a set of flat array-shaped sensor element modules is used, sensitivity correction of the X-ray detector is performed before the start of inspection operation, and calibration processing for suppressing blurring, unnecessary gradation, and the like of an X-ray transmission image is often performed, at which time an operation confirmation for checking inspection performance of the article inspection apparatus (hereinafter, also simply referred to as performance confirmation) is executed.

As this type of article inspection apparatus, for example, there is an article inspection apparatus including: a foreign matter determination unit that determines, based on a detection signal of an X-ray transmission amount of X-rays transmitted through an inspection object, the detection signal being output from an X-ray detection unit, whether or not foreign matter is contained in an inspection object; and an operation confirmation processing unit that determines whether or not the X-ray detection unit and the foreign matter determination unit operate correctly using a foreign matter sample, in which, in order to determine whether or not the X-ray detection unit and the foreign matter determination unit operate correctly, the operation confirmation processing unit checks whether a signal level of the detection signal from the X-ray detection unit falls within a predetermined allowable range in which the foreign matter sample designated for each product type of the inspection object can be specified, and executes operation confirmation regarding inspection performance (see, for example, Patent Document 1).

There is known an article inspection apparatus configured such that, as passage detection means for an article being transported, first passage detection means is disposed upstream of an X-ray inspection unit in a transport direction, and second passage detection means is disposed upstream of the first passage detection means in the transport direction, whereby, in a case where a foreign matter sample is introduced into a transport section between passage positions of the first and second passage detection means, when the second passage detection means does not detect passage of an inspection object and the first passage detection means detects passage of the inspection object, an operation mode is automatically switched from a normal inspection mode to an operation confirmation mode (see, for example, Patent Document 2).

### Related art Document

### Patent Document

[Patent Document 1] JP-A-2009-031149

[Patent Document 2] JP-A-2013-113784

### DISCLOSURE OF THE INVENTION

### Problem that the Invention is to Solve

However, in the conventional article inspection apparatus described above, since not only is preparation work for a foreign matter sample and the like required, but also performance confirmation thereof cannot be executed during operation of executing article inspection, cumbersome performance confirmation had to be executed before the start of operation, at the time of the end of operation, or at every elapse of a predetermined time after the start of operation.

In addition, inspection performance of the article inspection apparatus may degrade because of continuation of operation, and a performance degradation factor thereof may also change depending on an environment where the article inspection apparatus is installed or an operating status. Therefore, in order to stably maintain the inspection performance of each article inspection apparatus, cumbersome performance confirmation has to be executed, for example, every day, at relatively short time intervals, and there has been a problem that improvement of production efficiency in a production line of food, pharmaceuticals, and the like where the article inspection apparatus is installed is not easy.

Further, when a mistake such as forgetting to return the foreign matter sample for performance confirmation occurs, downtime occurs in the production line of the article, and there has also been a problem that the production efficiency thereof decreases.

Accordingly, an object of the present invention is to provide an article inspection apparatus and a performance confirmation method thereof capable of accurately and automatically detecting degradation of inspection performance, thereby effectively reducing the number of times of cumbersome performance confirmation by manual intervention while reliably maintaining inspection performance.

### Means for solving the problem

As an example of an embodiment, there is provided an article inspection apparatus including: a transport belt configured to transport an article in a state in which the article is placed thereon; an X-ray detector including a plurality of light-receiving elements, and configured to detect X-rays transmitted through the article and output a detection signal that enables image formation; an image processing unit configured to execute predetermined image processing on an X-ray inspection image based on the detection signal and output a processed image having an image feature indicating a quality state of the article; a determination unit configured to determine pass/fail of the quality state of the article based on the processed image; a reference image storage unit configured to store a reference image of a non-defective product of the article; a sensitivity correction unit configured to execute light reception sensitivity correction of adjusting a value of the detection signal from the X-ray detector when the X-rays are transmitted through the transport belt without being transmitted through the article to a predetermined reference value for the plurality of light-receiving elements, and output the X-ray inspection image after the correction; an image quality change detection unit configured to detect an occurrence of a change or a change factor of image quality in the X-ray inspection image; an evaluation image generation unit configured to generate an evaluation image obtained by synthesizing the reference image with the X-ray inspection image after the correction when the occurrence of the change or the change factor is detected by the image quality change detection unit; and an inspection performance evaluation unit configured to determine propriety of a determination result of the determination unit after causing the image processing unit to perform the predetermined image processing on the evaluation image generated by the evaluation image generation unit.

With this configuration, when a change or a change factor of image quality in the X-ray inspection image occurs and the change or the change factor is detected by the image quality change detection unit, an evaluation image obtained by synthesizing the reference image with the X-ray inspection image after the correction output from the sensitivity correction unit is generated by the evaluation image generation unit, and the inspection performance evaluation unit determines propriety of the determination result by causing the determination unit to determine pass/fail of the article after causing the image processing unit to execute the predetermined image processing on the evaluation image. Therefore, the presence or absence of degradation of inspection performance can be accurately and automatically detected. As a result, it is possible to effectively reduce the number of times of cumbersome performance confirmation by manual intervention while reliably maintaining inspection performance.

As an example of an embodiment, the reference image storage unit may be configured to store at least an image of a master work used for condition settings of the predetermined image processing as the reference image for determining the change in image quality of the X-ray inspection image.

In this manner, it is possible to create the evaluation image using the reference image that reliably matches the conditions of the predetermined image processing, and when the occurrence of the change or the change factor of image quality in the X-ray inspection image is detected, the presence or absence of degradation of inspection performance can be more accurately and automatically detected.

As an example of an embodiment, the reference image storage unit may be configured to store a non-defective product image of an article determined as a non-defective product by the determination unit as the reference image for determining the change in image quality of the X-ray inspection image.

This configuration can be employed in a case where the non-defective product image of the article equivalent to or more suitable than the article used as a master work can be created by the predetermined image processing, for example, in a case where an article of another product type similar to the master work is inspected under condition settings of the predetermined image processing, and when the occurrence of the change or the change factor of image quality in the X-ray inspection image is detected, the presence or absence of degradation of inspection performance for the article of the other product type can be more accurately and automatically detected.

As an example of an embodiment, the image quality change detection unit may be configured to detect the occurrence of the change or the change factor of image quality in the X-ray inspection image when a total X-ray irradiation time by an X-ray generator that irradiates the article with X-rays reaches a predetermined time.

This configuration can be employed in a case where an apparatus characteristic is such that image quality of the X-ray inspection image begins to degrade significantly when the total X-ray irradiation time by the X-ray generator reaches the predetermined time, and degradation of image quality of the X-ray inspection image can be effectively and automatically detected in advance.

As an example of an embodiment, the image quality change detection unit may be configured to detect the occurrence of the change or the change factor of image quality in the X-ray inspection image in a case where a brightness value indicated by the detection signal of the X-ray detector falls below a predetermined value at a start of sensitivity correction of the X-ray detector.

With this configuration, when the brightness value indicated by the detection signal of the X-ray detector falls below the predetermined value at the start of sensitivity correction of the X-ray detector and a probability that image quality of the X-ray inspection image degrades is very high, degradation of inspection performance can be accurately and automatically detected in advance.

As an example of an embodiment, the image quality change detection unit may be configured to acquire a brightness detection signal of X-rays transmitted only through an article non-placement region of the transport belt from the X-ray detector, and detect the occurrence of the change or the change factor of image quality in the X-ray inspection image when an average value of the brightness detection signal of X-rays transmitted only through the article non-placement region falls outside a predetermined range.

In this case, when the average value of the brightness detection signal of X-rays transmitted only through the article non-placement region of the transport belt falls outside the predetermined range and a probability that image quality of the X-ray inspection image degrades is very high, degradation of inspection performance can be accurately and automatically detected in advance.

As an example of an embodiment, the image quality change detection unit may be configured to acquire a brightness detection signal of X-rays transmitted only through an article non-placement region of the transport belt from the X-ray detector, and detect the occurrence of the change or the change factor of image quality in the X-ray inspection image when a noise level of the brightness detection signal of X-rays transmitted only through the article non-placement region exceeds a predetermined level value.

In this case, when the noise level of the brightness detection signal of X-rays transmitted only through the article non-placement region of the transport belt exceeds the predetermined level value and a probability that image quality of the X-ray inspection image degrades is very high, degradation of inspection performance can be accurately and automatically detected in advance.

As an example of an embodiment, the image quality change detection unit may be configured to calculate a defect occurrence rate in a predetermined number of inspected articles W based on a pass/fail determination result of the determination unit, and detect the occurrence of the change or the change factor of image quality in the X-ray inspection image when the defect occurrence rate exceeds a predetermined defect occurrence rate.

In this case, in a case where the defect occurrence rate in the predetermined number of inspected articles W increases rapidly, it is assessed that there is a high likelihood that degradation of image quality of the X-ray inspection image is occurring, and by detecting the occurrence of the change factor of the image quality, a performance degradation state can be automatically detected and confirmed rapidly and accurately.

As an example of an embodiment, the image quality change detection unit may be configured to detect the occurrence of the change or the change factor of image quality in the X-ray inspection image in a case where an ambient temperature of the X-ray detector exhibits a predetermined temperature change compared to a temperature at a time of sensitivity correction of the X-ray detector.

In this case, for example, by providing a temperature sensor for monitoring the ambient temperature of the X-ray detector, and in a case where the temperature change from the temperature at the time of sensitivity correction exceeds a predetermined allowable range, assessing that there is a high likelihood that degradation of image quality of the X-ray inspection image is occurring, and detecting the occurrence of the change factor of the image quality, a performance degradation state can be automatically detected and confirmed rapidly and accurately.

As an example of an embodiment, there is provided a performance confirmation method of an article inspection apparatus, the performance confirmation method being for confirming inspection performance of the article inspection apparatus, the article inspection apparatus including a transport belt configured to transport an article in a state in which the article is placed thereon, an X-ray detector including a plurality of light-receiving elements, and configured to detect X-rays transmitted through the article and output a detection signal that enables image formation, an image processing unit configured to execute predetermined image processing on an X-ray inspection image based on the detection signal and output a processed image having an image feature indicating a quality state of the article, and a determination unit configured to determine pass/fail of the quality state of the article based on the processed image, the performance confirmation method including: a reference image storage step of storing a reference image of a non-defective product of the article; a sensitivity correction step of executing light reception sensitivity correction of adjusting a value of the detection signal from the X-ray detector when the X-rays are transmitted through the transport belt without being transmitted through the article to a predetermined reference value for the plurality of light-receiving elements, and outputting the X-ray inspection image after the correction; an image quality change detection step of detecting an occurrence of a change factor of image quality in the X-ray inspection image; an evaluation image generation step of generating an evaluation image obtained by synthesizing the reference image with the X-ray inspection image after the correction when the change or the change factor is detected in the image quality change detection step; and an inspection performance evaluation step of determining propriety of a determination result of the determination unit after causing the image processing unit to execute the predetermined image processing on the evaluation image generated in the evaluation image generation step.

With this configuration, when the change or the change factor of image quality in the X-ray inspection image occurs and the change or the change factor is detected in the image quality change detection step, the evaluation image obtained by synthesizing the reference image with the X-ray inspection image after the correction is generated in the evaluation image generation step, and in the inspection performance evaluation step, propriety of the determination result is determined by causing the determination unit to determine pass/fail of the article after causing the image processing unit to execute the predetermined image processing on the evaluation image. Therefore, the presence or absence of degradation of inspection performance can be accurately and automatically detected, and as a result, it is possible to effectively reduce the number of times of cumbersome performance confirmation by manual intervention while reliably maintaining inspection performance.

### ADVANTAGE OF THE INVENTION

According to the present invention, it is possible to provide an article inspection apparatus and a performance confirmation method thereof capable of accurately and automatically detecting degradation of inspection performance, thereby effectively reducing the number of times of cumbersome performance confirmation by manual intervention while reliably maintaining inspection performance.

### BRIEF DESCRIPTION OF THE DRAWINGS

FIG. 1 is a schematic configuration diagram of a main part of an article inspection apparatus according to one embodiment of the present invention.

FIG. 2 is an explanatory diagram of a setting operation screen at the time of automatic setting for each product type in the article inspection apparatus according to one embodiment of the present invention.

FIG. 3 is a flowchart showing a schematic setting procedure at the time of automatic setting for each product type in the article inspection apparatus according to one embodiment of the present invention.

FIG. 4 is a flowchart showing a processing procedure of performance confirmation in sensitivity correction immediately after the start of operation or switching of a product type in the article inspection apparatus according to one embodiment of the present invention.

FIG. 5 is a flowchart showing a processing procedure of performance confirmation while executing inspection operation after the start of operation or switching of a product type in the article inspection apparatus according to one embodiment of the present invention.

FIG. 6 is an explanatory diagram of an image file of a defective part for each product type used for generating an evaluation image for NG determination in the article inspection apparatus according to one embodiment of the present invention.

### BEST MODE FOR CARRYING OUT THE INVENTION

Hereinafter, modes for carrying out the present invention will be described with reference to the drawings.

### One Embodiment

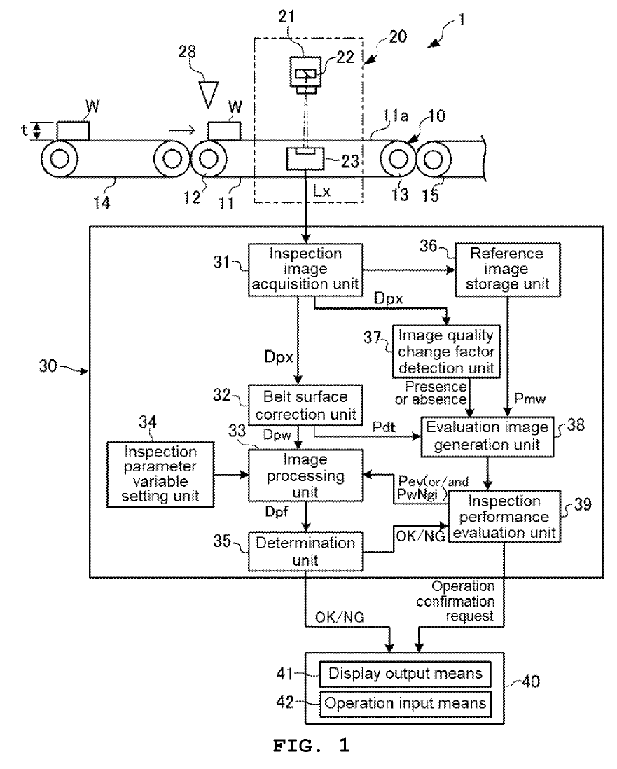

FIGS. 1 to 6 are diagrams showing an article inspection apparatus according to one embodiment of the present invention.

First, a configuration will be described.

As shown in FIG. 1, an article inspection apparatus 1 according to one embodiment of the present invention includes an article transport unit 10, an X-ray imaging unit 20, a control unit 30, and a display operation unit 40, and constitutes a part of an article inspection system in which a sorting device or the like (not shown in detail) is provided downstream of the article transport unit 10.

This article inspection apparatus 1 is an apparatus that inspects an article W, which is an inspection product, with X-rays capable of being transmitted therethrough, and has a foreign matter detection function of determining, for example, whether or not foreign matter is mixed into the inspection article W with X-rays, or has functions such as missing item inspection, mass inspection, inspection of a shape such as a thickness and a length of the inspection article W, and detection of packaging defects such as biting of contents into a seal part.

The article transport unit 10 serves as an inspection conveyor that transports the article W in a direction of a rightward arrow in FIG. 1 (transport direction) and is configured to transport the article W placed on a transport path 11a serving as an upper run section of a belt in a placed state by driving with a motor any of rollers 12 and 13 around which, for example, a loop-shaped inspection belt 11 is wound, and to cause the article W to pass through the inside of an inspection region by the X-ray imaging unit 20. Further, an upstream conveyor 14 and a downstream conveyor 15 that operate at the same transport speed are provided before and after the article transport unit 10, and an article detection sensor 28 that detects the article W immediately after being carried onto the transport path 11a is provided immediately after a transfer section from the upstream conveyor 14 to the article transport unit 10.

The X-ray imaging unit 20 includes an X-ray generator 21 and an X-ray detector 23 disposed with the transport path 11a of the article transport unit 10 interposed therebetween. Here, the X-ray generator 21 and the X-ray detector 23 are disposed so as to face each other while being separated vertically in a vertical direction but may be disposed so as to be separated in both the vertical direction and a horizontal direction.

Although details are not shown, the X-ray generator 21 has a configuration in which, for example, an X-ray tube 22 is provided inside a metal box body, and the X-ray tube 22 is immersed in insulating oil for cooling in the box body. This X-ray generator 21 is an X-ray irradiation unit that emits X-rays from the X-ray tube 22 toward a predetermined inspection region on the transport path 11a of the article W.

The X-ray tube 22 is disposed, for example, in a state in which an axial direction thereof is directed in a direction substantially parallel to a predetermined transport direction, and is configured such that, on a cathode side thereof, electrons are emitted from a filament lit at a high temperature by applying a direct current negative potential while being focused by a focusing electrode, and on an anode side thereof, a direct current positive potential is applied to a target to accelerate the electrons from the filament by a high voltage to cause the electrons to collide with the target, thereby generating X-rays in a predetermined energy range from the target.

Then, the X-rays generated by the X-ray tube 22 are emitted downward from an X-ray window part on a bottom side of the above-described box body toward an inspection region into which the article W is carried, in a fan beam shape spreading in a line scanning direction orthogonal to the transport direction. Note that an anode of the X-ray tube 22 may be of a fixed type or a rotating type.

The X-ray imaging unit 20 also includes a filament power supply circuit (not shown) and a high voltage circuit that applies a high voltage between the filament and the target of the X-ray tube 22.

Although details are not shown, the X-ray detector 23 is, for example, a line sensor disposed directly below the transport path 11a of the inspection belt 11 and including a scintillator that absorbs X-rays of predetermined energy (wavelength, transmission power) to emit light, and a photodiode array composed of N (for example, several hundred) light-receiving elements arranged in a direction orthogonal to the transport direction of the article W so as to receive light (scintillation light) from the scintillator. The X-ray detector 23 is configured to cause the scintillator to absorb X-rays emitted onto and transmitted through the article W to emit light in accordance with transmission intensity of the X-rays and output an electrical signal corresponding to an amount of light received by the photodiode for each predetermined scanning period. Note that the X-ray detector 23 is not limited to an indirect conversion type that indirectly converts X-rays into electrical signals in this way and may of course be of a direct conversion type.

The photodiode array of the X-ray detector 23 is configured to accumulate photocurrents simultaneously generated in the N light-receiving elements for a predetermined accumulation time, and output a brightness detection signal Lx, which is a voltage signal, based on electric charges corresponding to a product of the photocurrent and the accumulation time.

The control unit 30 is configured by hardware including, although a detailed configuration is not shown, a microcomputer including, for example, a CPU, a ROM, a RAM, and an I/O interface, an auxiliary storage device that stores, in a readable manner, a control program for exhibiting various functions in cooperation with the ROM, a timer circuit, a driver circuit, and the like, and is configured such that the CPU executes predetermined arithmetic processing while transmitting and receiving data to and from the RAM and the like in accordance with software such as the control program and setting information stored in the ROM and the like, and executes the control program. The hardware may include a field programmable gate array (FPGA), a digital signal processor (DSP), and the like. Additionally, the various functions referred to here are functions of respective functional units and means for X-ray output control, generation of X-ray image data, inspection control, display output control, and the like to be described below.

This control unit 30 has a transport control function of controlling a transport speed, a transport interval, and the like of the article W by the inspection belt 11 in the article transport unit 10, and an inspection control function of controlling X-ray irradiation intensity and an irradiation period in the X-ray imaging unit 20, controlling an X-ray detection cycle and a detection period of each article W in the X-ray detector 23 corresponding to the transport speed of the article W, and the like. Note that since the configuration of the transport control function is the same as a known configuration, detailed illustration thereof is omitted here.

First, as a plurality of functional units required for exhibiting the inspection control function, the control unit 30 includes an inspection image acquisition unit 31, a belt surface correction unit 32, an image processing unit 33, an inspection parameter variable setting unit 34, and a determination unit 35.

Specifically, the inspection image acquisition unit 31 is configured to sequentially detect X-rays transmitted through the inspection article W being transported by the X-ray detector 23 which is an X-ray line sensor, output the brightness detection signal Lx from the photodiode array of the X-ray detector 23, and acquire image data of a multi-gradation X-ray inspection image Dpx corresponding to an X-ray transmission amount distribution.

In addition, the belt surface correction unit 32 serves as a sensitivity correction unit that executes correction of adjusting values of the brightness detection signals Lx from the X-ray detector 23 for the plurality of light-receiving elements to a white reference value, respectively, that is, light reception sensitivity correction (so-called shading correction) on a belt surface, when X-rays from the X-ray generator 21 are transmitted only through the transport path 11a which is a belt surface before the article W is carried in (when there is no article W), and that outputs an X-ray inspection image Dpw after the light reception sensitivity correction. Hereinafter, the light reception sensitivity correction on the belt surface by the belt surface correction unit 32 is simply referred to as belt surface correction.

The image processing unit 33 executes predetermined filter processing on the X-ray inspection image Dpw after the light reception sensitivity correction taken in from the inspection image acquisition unit 31 via the belt surface correction unit 32, and performs image processing of facilitating extraction of an image feature corresponding to a morphological feature of a defective site which is a detection target related to article inspection, or measurement of a feature amount of the extracted image feature. That is, in the image processing unit 33, in order to execute predetermined article inspection based on image data of the X-ray inspection image Dpw after the light reception sensitivity correction, a predetermined inspection algorithm obtained by combining a plurality of image processing filters is set and stored, and a processed image Dpf subjected to such filter processing is output.

The inspection algorithm referred to here is a processing program for extracting an image feature necessary for detection of the defective site related to article inspection from the image data obtained from the X-ray inspection image Dpx of the article W, and in a case where the inspection algorithm includes a filter for foreign matter detection, the filter is, in the present embodiment, a feature extraction filter that performs enhancement processing of a contour (edge) of foreign matter on the X-ray inspection image Dpw after the light reception sensitivity correction, or a differential filter such as, for example, a Sobel filter, that performs differential processing or the like based on a predetermined arithmetic expression on a neighboring region of a pixel of interest to enhance the edge of the foreign matter.

Further, the feature measurement for obtaining the feature amount of the image feature is processing of measuring an image feature amount necessary for determination processing in the determination unit 35 by executing calculation regarding, for example, a gray scale feature, a color feature, a shape feature, and the like on the X-ray inspection image Dpf subjected to image processing advantageous for feature extraction in the image processing unit 33.

The determination unit 35 is configured to execute determination processing of determining the presence or absence of a predetermined quality state of the article W based on measurement data of the feature amount extracted by the image processing unit 33, for example, determination processing such as presence or absence of mixed foreign matter, and presence or absence of a missing item, pass/fail of a shape, a size, or a storage state of contents. This determination unit 35 is configured to detect a characteristic shape of the defective part, foreign matter, or the like detected in the article W, based on the measurement data of the feature amount of the processed image Dpf, and compare a feature amount such as an area, a contour length, and a density sum of the detection target with a predetermined determination reference value (hereinafter, referred to as a predetermined determination reference), thereby executing determination processing as to whether or not a local characteristic shape or the like corresponding to the foreign matter or the defective site satisfying a determination condition is contained in the article W.

The determination unit 35 is further configured to display and output pass/fail information OK or NG of a determination result for each article W using display output means 41 of the display operation unit 40 or further execute output in other forms (a notification sound, a message voice, data transmission output to the outside) together with the display output.

The control unit 30 also includes a reference image storage unit 36, an image quality change factor detection unit 37, an evaluation image generation unit 38, and an inspection performance evaluation unit 39 as a performance confirmation control function unit capable of exhibiting an inspection performance confirmation function.

Here, the reference image storage unit 36 is means for storing X-ray image data acquired as an inspection image of a representative work of the article W, and stores at least an image of a master work used for condition settings of the predetermined image processing such as filter processing used in the image processing unit 33 as a reference image Pmw for determining a change in image quality of the X-ray inspection image Dpx.

The reference image storage unit 36 may store any of non-defective product images of the article W determined as a non-defective product (OK product) by the determination unit 35 as the reference image Pmw for each product type for determining the change in image quality of the X-ray inspection image Dpx.

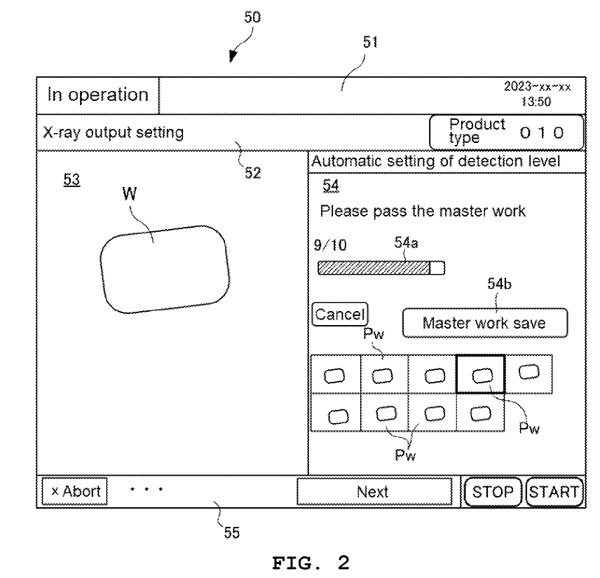

Specifically, as shown in an operation screen 50 for reference image registration shown in FIGS. 1 and 2, at the time of automatic setting for setting various inspection parameters in the inspection parameter variable setting unit 34 according to a product type of the article W, the article W (product) is actually transported a plurality of times to perform X-ray imaging a plurality of times, images are saved in the reference image storage unit 36, and by selecting a master work image or other reference images Pmw capable of being a non-defective product image suitable for inspection from a plurality of work images Pw (entire images) which are a plurality of X-ray inspection images of the imaged article W, a detection level of image density (brightness value) suitable for the image acquisition can be set and saved. Note that the automatic setting referred to here will be described below.

In FIG. 2, for example, in a state in which a work image Pw in a thick line frame portion in the operation screen 50 is selected by a touch operation, the reference image Pmw is saved by pressing a master work save button 54b. In FIG. 2, the operation screen 50 is disposed such that a display region 52 in which a current operation mode is displayed is disposed below an operation status display region 51 on an uppermost stage side, and an inspection image display region 53 in which the X-ray inspection image Dpx of the X-ray imaged article W is displayed, and a display region 54 of information on operation contents and operation targets related to the current operation mode are disposed below the display region 52. Additionally, in an operation input unit display region 55 on a lowermost stage side of the operation screen 50, an operation input unit such as a "Next" button for transitioning display screen contents of the operation screen 50 in a predetermined procedure or a "Abort" button for issuing an instruction to abort a current operation is displayed. Then, whether the article inspection apparatus 1 is in an operation state or a stopped state is displayed on a left end side in the figure of the operation status display region 51, common information common to both states is displayed on a right side thereof, the X-ray inspection image Dpx of the article W is displayed in the inspection image display region 53, and under a state in which the number of stored images of the plurality of work images Pw imaged during the automatic setting (in a display bar 54a in FIG. 2, the number of stored images is 9, and the number of storable images is 10) is displayed in the display region 54, selection and saving operations of an image to be the reference image Pmw are performed.

The description returns to FIG. 1. The image quality change factor detection unit 37 is means (image quality change detection unit) for detecting an occurrence of a change or a change factor of image quality in the X-ray inspection image, and is configured to detect, that is, assess and detect, the occurrence of the image quality change factor, presuming that an image quality change factor that degrades the image quality in the X-ray inspection image Dpx has occurred, for example, when a total energization time to the X-ray detector 23 reaches a predetermined time set as a service life time.

Further, the image quality change factor detection unit 37 is configured to detect the occurrence of the image quality change factor, presuming that a change or a factor of the change of image quality in the X-ray inspection image Dpx has occurred, in a case where a brightness value indicated by the brightness detection signal Lx from the X-ray detector 23 falls below a predetermined value at the start of sensitivity correction of the X-ray detector 23.

Furthermore, the image quality change factor detection unit 37 is configured to acquire a part of the brightness detection signal Lx of X-rays transmitted only through an article non-placement region (a region close to a white reference level at the time of sensitivity correction) of the transport belt 11 from the X-ray detector 23, and detect the occurrence of the image quality change factor, presuming that a change or a change factor of image quality in the X-ray inspection image Dpx has occurred, when an average value of the part of the brightness detection signal Lx of X-rays transmitted only through the article non-placement region falls outside a predetermined range.

In addition, the image quality change factor detection unit 37 is configured to acquire a part of the brightness detection signal Lx of X-rays transmitted only through the article non-placement region of the transport belt 11 from the X-ray detector 23, and detect the occurrence of the image quality change factor, presuming that a factor that degrades the image quality in the X-ray inspection image Dpx has occurred, when a noise level of the part of the brightness detection signal Lx of X-rays transmitted only through the article non-placement region exceeds a predetermined level value serving as an image quality degradation factor.

The image quality change factor detection unit 37 is also configured to calculate a defect occurrence rate in a predetermined number of most recent inspected articles W based on the pass/fail determination result of the determination unit 35 for a plurality of articles W, and detect the occurrence of the image quality change factor, presuming that a factor that degrades the image quality in the X-ray inspection image Dpx has occurred, when the defect occurrence rate exceeds a predetermined defect occurrence rate.

The image quality change factor detection unit 37 is provided with a temperature sensor (not shown) for monitoring an ambient temperature of the X-ray detector 23 in the vicinity of the X-ray detector 23, and is configured to detect the occurrence of the image quality change factor, presuming that an image quality change factor that degrades the image quality in the X-ray inspection image Dpx has occurred, in a case where there is a predetermined temperature change (a temperature change exceeding a predetermined allowable range) compared to a temperature at the time of sensitivity correction of the X-ray detector 23.

The evaluation image generation unit 38 is means for generating an evaluation image Pev (= Pmw + Pdt) obtained by synthesizing a belt surface corrected image Pdt from the belt surface correction unit 32 with the reference image Pmw from the reference image storage unit 36 by predetermined image synthesis processing when an occurrence of a change or a change factor of image quality is detected by the image quality change factor detection unit 37, or means for generating an evaluation image PwNgi (= Pmw + Pdt + Ngi) made to have a defective image feature by further additionally synthesizing an image Ngi of only a predetermined defective part. The predetermined image synthesis processing referred to here is image processing of replacing, for example, pixel values of a part of a pixel region in an image region of a belt surface image in the reference image Pmw, in which brightness falls within a predetermined range effective for synthesis, with pixel values of a part of the belt surface corrected image Pdt from the belt surface correction unit 32 when the occurrence of the image quality change factor is detected by the image quality change factor detection unit 37, or image processing of further transforming the part of the pixel region to have an image feature of the image Ngi of the predetermined defective part, and more specifically, is processing of performing, for example, replacement or interpolation of pixel values (brightness values) in the pixel region, texture synthesis, or the like. Although the number of syntheses and synthesis positions of the belt surface image with respect to the reference image Pmw at the time of occurrence of the image quality change factor are not particularly limited, it is preferable that at least one is set at a position suitable for the above-described synthesis processing and pass/fail determination according to the reference image Pmw.

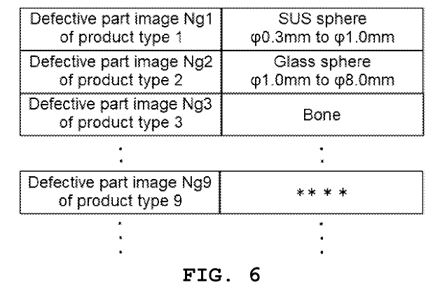

In a case where the evaluation image is made to have the image feature of the image Ngi of the predetermined defective part, the image Ngi of only the predetermined defective part is, for example, as shown in FIG. 6, a plurality of images prepared as images of different types of samples to be detected or test pieces replacing the samples, or images of other defective parts. In FIG. 6, images of a plurality of spherical test pieces of stainless steel (SUS) having a diameter of 0.3mm to 1.0mm are prepared as a defective part image Ng1 corresponding to foreign matter to be detected in a case where the foreign matter is mixed into an article W of product type 1. Additionally, in FIG. 6, images of a plurality of spherical test pieces of glass having a diameter of 1.0mm to 8.0mm are prepared as a defective part image Ng2 corresponding to foreign matter to be detected in a case where the foreign matter is mixed into an article W of product type 2, an image of a sample of a bone that may remain in the article W is prepared as a defective part image Ng3 corresponding to foreign matter to be detected in a case where the foreign matter is mixed into an article W of product type 3, and an image of a sample of a defective part that may occur in the article W, for example, a seal defective part of a package, is prepared as a defective part image Ng9 corresponding to a defective part to be detected in a case where the defective part has occurred in an article W of product type 9. It is a matter of course that other defective part images may be included.

The inspection performance evaluation unit 39 is configured to, when a change or a change factor of image quality in the X-ray inspection image Dpx is detected by the image quality change factor detection unit 37, cause the image processing unit 33 to execute predetermined image processing on the evaluation image Pev and/or PwNgi generated by the evaluation image generation unit 38, and then determine propriety of a determination result OK/NG of the determination unit 35, that is, determine and verify whether or not accurate performance determination can be performed by checking whether a determination result of the evaluation image Pev to be determined as OK is OK determination, and/or a determination result of the evaluation image PwNgi to be determined as NG is NG determination.

The display operation unit 40 is configured as a touch panel including the display output means 41 and operation input means 42, but the display output means 41 may also have functions of output means of a voice or a notification sound or data transmission output means as described above. Further, the operation input means 42 may also have functions of voice input or data reception means (not shown).

The article inspection apparatus 1 of the present embodiment includes, in this way, the reference image storage unit 36 that stores the reference image Pmw of the non-defective product of the article W, the image quality change factor detection unit 37, the evaluation image generation unit 38 configured to generate the evaluation image Pev (= Pmw + Pdt) obtained by synthesizing the belt surface corrected image Pdt at the time of occurrence of the image quality change factor by the image quality change factor detection unit 37 with the reference image Pmw, and the inspection performance evaluation unit 39 that determines and verifies propriety of the determination result OK/NG of the determination unit 35 by causing the image processing unit 33 to execute predetermined image processing on the evaluation image Pev for OK determination and/or the evaluation image PwNgi for NG determination generated by the evaluation image generation unit 38 at the time of image quality change factor detection.

Next, one embodiment of a method for confirming inspection performance of this X-ray inspection apparatus will be described.

The performance confirmation method of the article inspection apparatus according to the present embodiment includes: an image quality change detection step of detecting an occurrence of a change factor of image quality in the X-ray inspection image Dpx; a reference image storage step of storing the reference image Pmw of the non-defective product of the article W in the reference image storage unit 36; an evaluation image generation step of generating the evaluation image Pev (= Pmw + Pdt) obtained by synthesizing the belt surface corrected image Pdt at that time with the reference image Pmw at least at the time of the occurrence of the image quality change factor detected by the image quality change factor detection unit 37, and/or generating the evaluation image PwNgi (= Pmw + Pdt + Ngi) made to have a defective image feature by further additionally synthesizing the image Ngi of the predetermined defective part; and an inspection performance evaluation step of determining propriety of the determination result OK or NG in the determination unit 35 after causing the image processing unit 33, which is an image processing unit, to execute predetermined image processing on the evaluation image Pev and/or PwNgi generated in the evaluation image generation step when the image quality change factor is detected in the image quality change detection step.

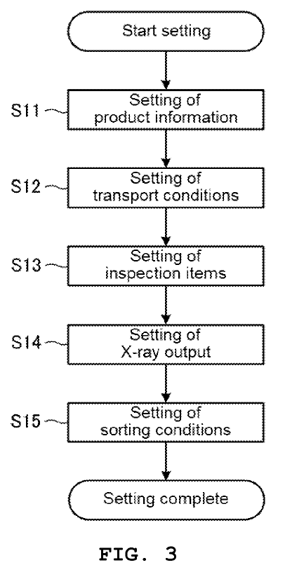

Hereinafter, one embodiment of the method for confirming inspection performance of this X-ray inspection apparatus will be described in association with specific control processing contents in the present embodiment as shown in FIGS. 3 to 5.

In processing of automatic setting shown in FIG. 3, first, setting of product information such as a product name of the article W is performed (step S11), and after setting of transport conditions such as a transport speed and a transport form (box shape, loose shape) of the article W is performed (step S12), setting of inspection items such as a foreign matter detection algorithm, shape inspection, biting inspection, mask setting, and the like is performed (step S13). Next, setting of X-ray output using the operation screen 50 shown in FIG. 2 is performed by actually transporting the product, and adjustment of a detection limit of the foreign matter detection algorithm or the like is executed (step S14). Next, setting of sorting conditions such as setting of operation timing of a downstream sorting device (not shown) is performed (step S15).

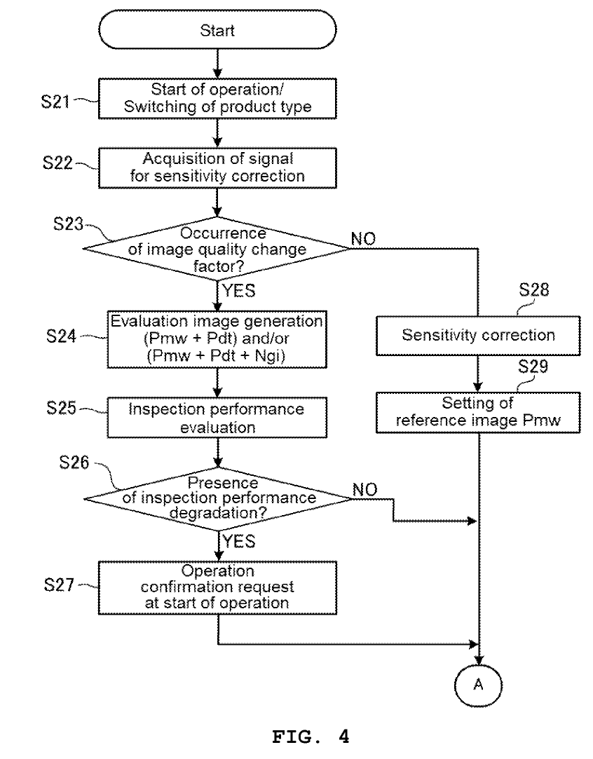

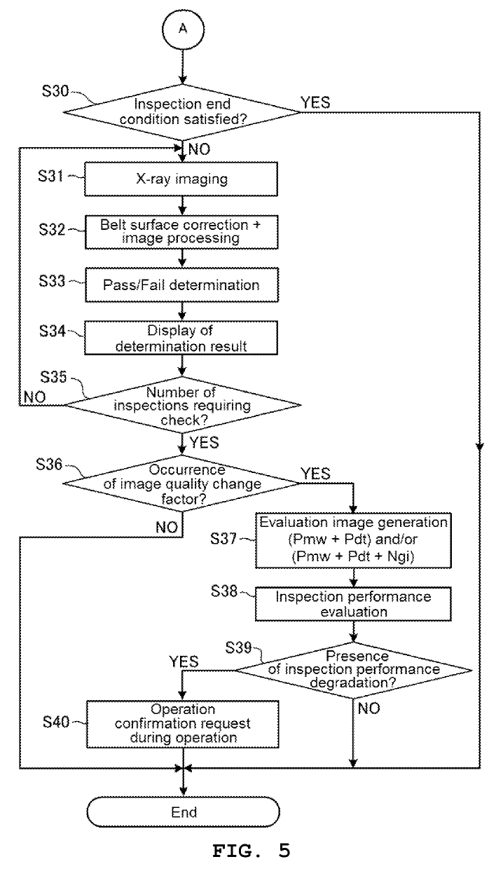

When such automatic setting is executed for a product type to be inspected, processing of performance confirmation at the time of start of operation or at the time of switching of a product type as shown in FIG. 4 is executed, and during subsequent inspection operation, processing of performance inspection as shown in FIG. 5 is executed.

First, as shown in FIG. 4, when operation of the article inspection apparatus 1 is started or switching of a product type of the article W is performed (step S21), in order to perform sensitivity correction in the belt surface correction unit 32, X-rays emitted from the X-ray generator 21 and transmitted only through the article non-placement region of the transport path 11a are detected by the X-ray detector 23, and the brightness detection signal Lx output from the X-ray detector 23 is acquired by the inspection image acquisition unit 31 (step S22).

Next, based on values of the brightness detection signals Lx from the N light-receiving elements of the X-ray detector 23 acquired by the inspection image acquisition unit 31 for sensitivity correction, processing of detecting the image quality change or the image quality change factor is performed by the image quality change factor detection unit 37, and it is determined whether or not at least the image quality change factor has occurred (step S23 (image quality change detection step)).

Note that, as described above, the image quality change factor is, for example, that the total energization time to the X-ray detector 23 has reached a predetermined time set as the service life time, that the brightness value indicated by the brightness detection signal Lx of the X-ray detector 23 has fallen below a predetermined value at the start of sensitivity correction of the X-ray detector 23, that the average value of a part of the brightness detection signal Lx of X-rays transmitted only through the article non-placement region of the transport belt 11 has fallen outside a predetermined range, that the noise level of a part of the brightness detection signal Lx of X-rays transmitted only through the article non-placement region has exceeded a predetermined level value serving as the image quality degradation factor, that the defect occurrence rate in a predetermined number of most recent inspected articles W has exceeded a predetermined defect occurrence rate, and the like.

Here, in a case where it is determined that the image quality change factor has occurred (YES in step S23), next, the evaluation image Pev (= Pmw + Pdt) obtained by synthesizing at least the belt surface corrected image Pdt at that time with the reference image Pmw is generated, and/or the evaluation image PwNgi (= Pmw + Pdt + Ngi) made to have a defective image feature by further additionally synthesizing the image Ngi of the predetermined defective part is generated by the evaluation image generation unit 38 (step S24 (evaluation image generation step)), and using the evaluation image Pev for OK determination and/or the evaluation image PwNgi for NG determination, the inspection performance evaluation unit 39 determines propriety of the determination result OK or NG in the determination unit 35 after causing the image processing unit 33, which is an image processing unit, to execute predetermined image processing (step S25 (inspection performance evaluation step)).

At this time, in a case where the determination result in the determination unit 35 for the evaluation image Pev for OK determination is OK determination, the inspection performance evaluation unit 39 determines that the non-defective product detection performance of the article inspection apparatus 1 is normal and there is no performance degradation. In addition, when using the evaluation image PwNgi for NG determination, in a case where the determination result in the determination unit 35 for the evaluation image PwNgi having the defective image feature is NG determination, the inspection performance evaluation unit 39 determines that the defect detection performance of the article inspection apparatus 1 is normal and there is no performance degradation (in the case of NO in step S26).

On the other hand, at this time, in a case where the determination result in the determination unit 35 for the evaluation image Pev for OK determination is NG determination or the determination result in the determination unit 35 for the evaluation image PwNgi for NG determination is OK determination, in that case, the inspection performance evaluation unit 39 determines that the inspection performance of the article inspection apparatus 1 is not normal and there is performance degradation (in the case of YES in step S26), and outputs an operation confirmation request to the display operation unit 40 (step S27).

Further, as a result of detection processing of the image quality change factor being performed by the image quality change factor detection unit 37 based on values of the brightness detection signals Lx from the N light-receiving elements of the X-ray detector 23 acquired by the inspection image acquisition unit 31 for sensitivity correction, in a case where it is determined that the image quality change factor has not occurred (in the case of NO in step S23), next, processing of sensitivity correction of adjusting values of the brightness detection signals Lx from the X-ray detector 23 acquired by the inspection image acquisition unit 31 for sensitivity correction for the N light-receiving elements to the white reference value, respectively, is executed (step S28).

Next, by performing the above-described X-ray output setting using the operation screen 50 shown in FIG. 2, a master image serving as the reference image Pmw for the article W of the selected product type can be stored and saved in the reference image storage unit 36 (step S29 (reference image storage step)).

When entering subsequent inspection operation, as shown in FIG. 5, first, it is checked whether or not a predetermined inspection end condition is satisfied. Note that it goes without saying that the processing shown in FIG. 5 is coupled to the processing shown in FIG. 4 by a connector (A), and is executed continuously from the processing shown in FIG. 4.

At the time of checking this inspection end condition, in a case where the predetermined inspection end condition is satisfied (in the case of YES in step S30), the current processing is ended without entering the inspection operation.

On the other hand, at this time, in a case where the predetermined inspection end condition is not satisfied (in the case of NO in step S30), the following processing involving inspection performance confirmation during inspection operation is executable.

First, the article W is X-ray imaged within the inspection region while being transported (step S31), image processing such as predetermined filter processing is executed by the image processing unit 33 on the belt surface corrected image Pdt from the belt surface correction unit 32 (step S32), pass/fail determination in the determination unit 35 is executed based on image data for determination after the image processing (step S33), and the determination result OK/NG is displayed by the display operation unit 40 (step S34).

Next, it is determined whether or not the number of inspections requiring a check has been reached (step S35). This number of inspections requiring a check is an interval of inspection performance confirmation set in advance as a predetermined number of inspections from a previous check of inspection performance until a next check of inspection performance is necessary.

At this time, in a case where the number of inspections requiring a check has not been reached (in the case of NO in step S35), the determination step S30 of determining whether or not the inspection end condition is satisfied is executed again, and then steps S31 to S35 of inspection of each article W are repeated.

On the other hand, at this time, in a case where the number of inspections requiring a check has been reached (in the case of YES in step S35), next, a determination as to whether or not an image quality change factor has occurred is made (step S36 (image quality change detection step)).

The occurrence of the image quality change factor here may be the same as in the case of the inspection performance confirmation processing at the time of start of operation, but it is also possible to determine the occurrence of the image quality change itself by directly detecting a change in image data that can be regarded as degradation of image quality based on the image data of the X-ray inspection image Dpx already acquired by the inspection image acquisition unit 31. In either case, by performing processing of detecting the image quality change or the image quality change factor thereof in the image quality change factor detection unit 37, it is determined whether or not at least the image quality change factor has occurred.

At this time, in a case where it is determined that the image quality change or the image quality change factor has not occurred (in the case of NO in step S36), the current processing is ended.

On the other hand, at this time, in a case where it is determined that the image quality change or the image quality change factor has occurred (in the case of YES in step S36), next, the evaluation image Pev (= Pmw + Pdt) obtained by synthesizing at least the belt surface corrected image Pdt at that time with the reference image Pmw is generated, and/or the evaluation image PwNgi (= Pmw + Pdt + Ngi) made to have the defective image feature by further additionally synthesizing the image Ngi of the predetermined defective part is generated by the evaluation image generation unit 38 (step S37 (evaluation image generation step)), and the inspection performance evaluation unit 39 executes performance evaluation of determining propriety of the determination result OK or NG in the determination unit 35 after causing the image processing unit 33 to execute predetermined image processing, using the evaluation image Pev for OK determination and/or the evaluation image PwNgi for NG determination as the evaluation image, respectively (step S38 (inspection performance evaluation step)).

The performance evaluation at this time is an evaluation such that it is determined that there is no performance degradation in a case where the determination result in the determination unit 35 for the evaluation image Pev for OK determination is OK determination, and/or it is determined that there is no performance degradation in a case where the determination result in the determination unit 35 for the evaluation image PwNgi for NG determination is NG determination, similarly to the case described above (NO in step S26) (in the case of NO in step S39).

On the other hand, at the time of this performance evaluation, in a case where the determination result in the determination unit 35 for the evaluation image Pev for OK determination is NG determination or the determination result in the determination unit 35 for the evaluation image PwNgi for NG determination is OK determination, it is determined that the inspection performance of the article inspection apparatus 1 is not normal and there is performance degradation (in the case of YES in step S39), and an operation confirmation request during operation is output to the display operation unit 40 (step S40).

Next, an operation will be described.

In the article inspection apparatus 1 of the present embodiment configured as described above, when a change or a change factor of image quality in the X-ray inspection image Dpx occurs and the change or the change factor is detected by the image quality change factor detection unit 37, the evaluation image Pev (= Pmw + Pdt) obtained by synthesizing at least the belt surface corrected image Pdt at that time with the reference image Pmw is generated, and/or the evaluation image PwNgi (= Pmw + Pdt + Ngi) made to have the defective image feature by further additionally synthesizing the image Ngi of the predetermined defective part is generated by the evaluation image generation unit 38, and the inspection performance evaluation unit 39 determines and evaluates propriety of the determination result OK or NG by causing the image processing unit 33 (image processing unit) to execute predetermined image processing and then causing the determination unit 35 to determine pass/fail of the article W. Therefore, the presence or absence of degradation of inspection performance can be accurately and automatically detected. As a result, it is possible to effectively reduce the number of times of operation confirmation for cumbersome performance confirmation by manual intervention while reliably maintaining inspection performance.

Further, in the present embodiment, since the reference image storage unit 36 can store at least an image of a master work used for condition settings of predetermined image processing as the reference image Pmw for determining a change in image quality of the X-ray inspection image, the evaluation image Pev and/or PwNgi can be generated using the reference image Pmw that reliably matches the conditions of the predetermined image processing, and when a change or a change factor of image quality in the X-ray inspection image Dpx is detected, the presence or absence of degradation of inspection performance can be more accurately and automatically detected.

Furthermore, in the present embodiment, since the non-defective product image of the article W determined as OK by the determination unit 35 can also be used as the reference image Pmw, in a case where a non-defective product image of the article W equivalent to or more suitable than the article W used as the master work can be created by predetermined image processing, for example, it can be employed in a case where an article W of another product type similar to the master work is inspected under condition settings of predetermined image processing, and when an occurrence of a change or a change factor of image quality in the X-ray inspection image Dpx factor is detected, the presence or absence of degradation of inspection performance with respect to the article W of the other product type can be more accurately and automatically detected.

In addition, in the present embodiment, in a case of an apparatus configuration and characteristic such that image quality of the X-ray inspection image Dpx begins to degrade significantly when the total energization time (total X-ray irradiation time) to the X-ray generator 21 reaches the predetermined time, degradation of image quality of the X-ray inspection image Dpx can be effectively and automatically detected in advance.

Further, in the present embodiment, when a brightness value indicated by the brightness detection signal Lx of the X-ray detector 23 falls below a predetermined value at the start of sensitivity correction of the X-ray detector 23 and a probability that image quality of the X-ray inspection image Dpx degrades is very high, degradation of inspection performance can be accurately and automatically detected in advance.

In the present embodiment, also, when an average brightness value of the brightness detection signal Lx of X-rays transmitted only through the article non-placement region of the transport belt 11 falls outside a predetermined range and a probability that image quality of the X-ray inspection image Dpx degrades is very high, this is detected as an occurrence of a performance degradation factor, so that degradation of inspection performance can be accurately and automatically detected in advance.

Furthermore, in the present embodiment, when the noise level of the brightness detection signal Lx of X-rays transmitted only through the article non-placement region of the transport belt 11 exceeds a predetermined level value and a probability that image quality of the X-ray inspection image Dpx degrades is very high, this is detected as an occurrence of a performance degradation factor, so that degradation of inspection performance can be accurately and automatically detected in advance.

Additionally, in the present embodiment, in a case where the defect occurrence rate in a predetermined number of inspected articles, for example, articles W of the number of inspections requiring a check corresponding to the interval of the inspection performance confirmation described above, increases rapidly, it is assessed that there is a high likelihood that degradation of image quality of the X-ray inspection image Dpx is occurring, and an occurrence of a change factor of image quality can be detected, so that a performance degradation state can be automatically detected and confirmed rapidly and accurately.

In addition, in the present embodiment, by monitoring the ambient temperature of the X-ray detector 23 by a temperature sensor provided in the image quality change factor detection unit 37, when the ambient temperature change from a temperature at the time of sensitivity correction exceeds a predetermined allowable range, it is assessed that there is a high likelihood that degradation of image quality of the X-ray inspection image Dpx is occurring, and by detecting an occurrence of a change factor of image quality, a performance degradation state can also be automatically detected and confirmed rapidly and accurately.

In this way, with the performance confirmation method of the article inspection apparatus 1 of the present embodiment, degradation of inspection performance of the article inspection apparatus 1 can be accurately and automatically detected, and the number of times of operation confirmation for cumbersome performance confirmation by manual intervention can be effectively reduced while reliably maintaining the inspection performance.

Note that, in the above-described one embodiment, the image processing unit 33 extracts and measures an image feature amount specific to foreign matter by executing filter processing and other predetermined image processing for foreign matter detection or the like, but the present invention is not limited thereto. For example, the image processing unit 33 may perform volume measurement using equivalent thickness image data of the X-ray inspection image Dpx as an image processing unit and perform mass conversion. However, in that case, the inspection performance evaluation unit 39 can use the evaluation image Pev for OK determination, but the evaluation image PwNgi for NG determination made to have a defective image feature is not used. On the other hand, in a case where foreign matter detection is performed, the image processing unit 33 performs image processing suitable for detecting and measuring a predetermined foreign matter feature amount in the article W, and the determination unit 35 can determine whether or not there is foreign matter in the article W according to whether or not the predetermined foreign matter feature amount is detected and measured using only the evaluation image PwNgi for NG determination, and can determine that there is no degradation of foreign matter detection performance in a case where there is foreign matter. It is a matter of course that the image processing unit 33 may execute image processing suitable for detection of an image feature of a defective part of any type.

As described above, the present invention can provide an article inspection apparatus and a performance confirmation method thereof capable of accurately and automatically detecting degradation of inspection performance, thereby effectively reducing the number of times of cumbersome performance confirmation by manual intervention while reliably maintaining inspection performance. The present invention is useful for general article inspection apparatuses that perform predetermined image processing on an X-ray inspection image of an article to determine a quality state of the article, and general performance confirmation methods for confirming whether or not there is performance degradation accompanied by degradation of image quality of the X-ray inspection image.

### DESCRIPTION OF REFERENCE NUMERALS AND SIGNS

1 Article inspection apparatus

10 Article transport unit

11 Inspection belt (Transport belt)

11a Transport path (Upper run section of belt, Article non-placement region)

12, 13 Roller

14 Upstream conveyor

15 Downstream conveyor

20 X-ray imaging unit

21 X-ray generator

22 X-ray tube

23 X-ray detector

28 Article detection sensor

30 Control unit

31 Inspection image acquisition unit

32 Belt surface correction unit (Sensitivity correction unit)

33 Image processing unit

34 Inspection parameter variable setting unit

35 Determination unit

36 Reference image storage unit

37 Image quality change factor detection unit (Image quality change detection unit)

38 Evaluation image generation unit

39 Inspection performance evaluation unit

40 Display operation unit

50 Operation screen

51 Operation status display region

52 Display region

53 Inspection image display region

54 Display region

54a Display bar

54b Master work save button

55 Operation input unit display region

Dpw X-ray inspection image after light reception sensitivity correction (Normal belt surface corrected image)

Dpx X-ray inspection image

Lx Brightness detection signal (Detection signal)

Ngi Image (Image of only defective part, Image of defective part)

Ng1, Ng2, Ng3, Ng9 Defective part image

NG Pass/fail information (Determination result, Defective product determination)

OK Pass/fail information (Determination result, Non-defective product determination)

Pdt Belt surface corrected image (X-ray inspection image after correction, X-ray inspection image after light reception sensitivity correction at the time of image quality degradation factor detection

Pev Evaluation image (Evaluation image for OK determination, Evaluation image at the time of sensitivity degradation)

Pmw Reference image (Image of master work, Image of article determined as non-defective product)

Pw Work image (Entire image of article)

PwNgi Evaluation image (Evaluation image for NG determination, Evaluation image at the time of sensitivity degradation)

S23, S36 Step (Image quality change detection step)

S24, S37 Step (Evaluation image generation step)

S25, S38 Step (Inspection performance evaluation step)

S29 Step (Reference image storage step)

t Thickness (Thickness of article)

W Article (Inspection product)

What is claimed is:

1. An article inspection apparatus comprising:
a transport belt configured to transport an article in a state in which the article is placed thereon;
an X-ray detector including a plurality of light-receiving elements, and configured to detect X-rays transmitted through the article and output a detection signal that enables image formation;
an image processing unit configured to execute predetermined image processing on an X-ray inspection image based on the detection signal and output a processed image having an image feature indicating a quality state of the article;
a determination unit configured to determine pass/fail of the quality state of the article based on the processed image;
a reference image storage unit configured to store a reference image of a non-defective product of the article;
a sensitivity correction unit configured to execute light reception sensitivity correction of adjusting a value of the detection signal from the X-ray detector when the X-rays are transmitted through the transport belt without being transmitted through the article to a predetermined reference value for the plurality of light-receiving elements, and output the X-ray inspection image after the correction;
an image quality change detection unit configured to detect an occurrence of a change or a change factor of image quality in the X-ray inspection image;
an evaluation image generation unit configured to generate an evaluation image obtained by synthesizing the reference image with the X-ray inspection image after the correction when the change or the change factor of the image quality is detected by the image quality change detection unit; and
an inspection performance evaluation unit configured to determine propriety of a determination result of the determination unit after causing the image processing unit to perform the predetermined image processing on the evaluation image generated by the evaluation image generation unit.

2. The article inspection apparatus according to claim 1,
wherein the reference image storage unit stores at least an image of a master work used for condition settings of the predetermined image processing as the reference image for determining the change in image quality of the X-ray inspection image.

3. The article inspection apparatus according to claim 1,
wherein the reference image storage unit stores a non-defective product image of an article determined as a non-defective product by the determination unit as the reference image for determining the change in image quality of the X-ray inspection image.

4. The article inspection apparatus according to claim 1,
wherein the image quality change detection unit detects the occurrence of the change or the change factor of image quality in the X-ray inspection image when a total X-ray irradiation time by an X-ray generator that irradiates the article with X-rays reaches a predetermined time.

5. The article inspection apparatus according to claim 1,
wherein the image quality change detection unit detects the occurrence of the change or the change factor of image quality in the X-ray inspection image in a case where a brightness value indicated by the detection signal of the X-ray detector falls below a predetermined value at a start of sensitivity correction of the X-ray detector.

6. The article inspection apparatus according to claim 1,
wherein the image quality change detection unit acquires a brightness detection signal of X-rays transmitted only through an article non-placement region of the transport belt from the X-ray detector, and detects the occurrence of the change or the change factor of image quality in the X-ray inspection image when an average value of the brightness detection signal of X-rays transmitted only through the article non-placement region falls outside a predetermined range.

7. The article inspection apparatus according to claim 1,
wherein the image quality change detection unit acquires a brightness detection signal of X-rays transmitted only through an article non-placement region of the transport belt from the X-ray detector, and detects the occurrence of the change of image quality in the X-ray inspection image when a noise level of the brightness detection signal of X-rays transmitted only through the article non-placement region exceeds a predetermined level value.

8. The article inspection apparatus according to claim 1,
wherein the image quality change detection unit calculates a defect occurrence rate based on a pass/fail determination result of the determination unit, and detects the occurrence of the change or the change factor of image quality in the X-ray inspection image when the defect occurrence rate exceeds a predetermined defect occurrence rate.

9. The article inspection apparatus according to claim 1,
wherein the image quality change detection unit detects the occurrence of the change or the change factor of image quality in the X-ray inspection image in a case where an ambient temperature of the X-ray detector exhibits a predetermined temperature change compared to a temperature at a time of sensitivity correction of the X-ray detector.

10. The article inspection apparatus according to claim 2,
wherein the image quality change detection unit detects the occurrence of the change or the change factor of image quality in the X-ray inspection image when a total X-ray irradiation time by an X-ray generator that irradiates the article with X-rays reaches a predetermined time.

11. The article inspection apparatus according to claim 2,
wherein the image quality change detection unit detects the occurrence of the change or the change factor of image quality in the X-ray inspection image in a case where a brightness value indicated by the detection signal of the X-ray detector falls below a predetermined value at a start of sensitivity correction of the X-ray detector.

12. The article inspection apparatus according to claim 2,
wherein the image quality change detection unit acquires a brightness detection signal of X-rays transmitted only through an article non-placement region of the transport belt from the X-ray detector, and detects the occurrence of the change or the change factor of image quality in the X-ray inspection image when an average value of the brightness detection signal of X-rays transmitted only through the article non-placement region falls outside a predetermined range.

13. The article inspection apparatus according to claim 2,
wherein the image quality change detection unit acquires a brightness detection signal of X-rays transmitted only through an article non-placement region of the transport belt from the X-ray detector, and detects the occurrence of the change or the change factor of image quality in the X-ray inspection image when a noise level of the brightness detection signal of X-rays transmitted only through the article non-placement region exceeds a predetermined level value.

14. The article inspection apparatus according to claim 2,
wherein the image quality change detection unit calculates a defect occurrence rate based on a pass/fail determination result of the determination unit, and detects the occurrence of the change or the change factor of image quality in the X-ray inspection image when the defect occurrence rate exceeds a predetermined defect occurrence rate.

15. The article inspection apparatus according to claim 2,
wherein the image quality change detection unit detects the occurrence of the change or the change factor of image quality in the X-ray inspection image in a case where an ambient temperature of the X-ray detector exhibits a predetermined temperature change compared to a temperature at a time of sensitivity correction of the X-ray detector.

16. The article inspection apparatus according to claim 3,
wherein the image quality change detection unit detects the occurrence of the change or the change factor of image quality in the X-ray inspection image when a total X-ray irradiation time by an X-ray generator that irradiates the article with X-rays reaches a predetermined time.

17. The article inspection apparatus according to claim 3,
wherein the image quality change detection unit detects the occurrence of the change or the change factor of image quality in the X-ray inspection image in a case where a brightness value indicated by the detection signal of the X-ray detector falls below a predetermined value at a start of sensitivity correction of the X-ray detector.

18. The article inspection apparatus according to claim 3,
wherein the image quality change detection unit acquires a brightness detection signal of X-rays transmitted only through an article non-placement region of the transport belt from the X-ray detector, and detects the occurrence of the change or the change factor of image quality in the X-ray inspection image when an average value of the brightness detection signal of X-rays transmitted only through the article non-placement region falls outside a predetermined range.

19. The article inspection apparatus according to claim 3,
wherein the image quality change detection unit acquires a brightness detection signal of X-rays transmitted only through an article non-placement region of the transport belt from the X-ray detector, and detects the occurrence of the change or the change factor of image quality in the X-ray inspection image when a noise level of the brightness detection signal of X-rays transmitted only through the article non-placement region exceeds a predetermined level value.

20. A performance confirmation method of an article inspection apparatus, the performance confirmation method being for confirming inspection performance of the article inspection apparatus, the article inspection apparatus including a transport belt configured to transport an article in a state in which the article is placed thereon, an X-ray detector including a plurality of light-receiving elements, and configured to detect X-rays transmitted through the article and output a detection signal that enables image formation, an image processing unit configured to execute predetermined image processing on an X-ray inspection image based on the detection signal and output a processed image having an image feature indicating a quality state of the article, and a determination unit configured to determine pass/fail of the quality state of the article based on the processed image, the performance confirmation method comprising:
a reference image storage step of storing a reference image of a non-defective product of the article;
a sensitivity correction step of executing light reception sensitivity correction of adjusting a value of the detection signal from the X-ray detector when the X-rays are transmitted through the transport belt without being transmitted through the article to a predetermined reference value for the plurality of light-receiving elements, and outputting the X-ray inspection image after the correction;
an image quality change detection step of detecting an occurrence of a change factor of image quality of the X-ray inspection image;
an evaluation image generation step of generating an evaluation image obtained by synthesizing the reference image with the X-ray inspection image after the correction when the change or the change factor of image quality is detected in the image quality change detection step; and
an inspection performance evaluation step of determining propriety of a determination result of the determination unit after causing the image processing unit to execute the predetermined image processing on the evaluation image generated in the evaluation image generation step.
